(19) United States
(12) Patent Application Publication
(10) Pub. No.: US 2007/0226471 A1
(43) Pub. Date: Sep. 27, 2007

(54) Data processing apparatus

(75) Inventors: Andrei Kapustin, Cambridge (GB); Yuri Levdik, Cambridge (GB); Vladimir Vasekin, Cambridge (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/373,514

(22) Filed: Mar. 13, 2006

(51) Int. Cl. G06F 9/44

(52) U.S. Cl. 712/227

(57) ABSTRACT

A data processing apparatus, method and watch point unit are disclosed. The data processing apparatus comprises: a processor core operable to process a sequence of instructions; and a watch point unit operable to receive an indication of each of the sequence of instructions being processed by the processor core, the watch point unit being operable to determine whether the indication of each of the sequence of instructions correlates with at least one watch point condition and, if so, the watch point unit being further operable to provide an indication that the at least one watch point condition occurred. Accordingly, watch point conditions can be set based on the instructions themselves rather than being based on a likely effect of that instruction. This enables a wider range of conditions of interest to be defined which expands the usefulness of debugging. Also, the determination of when the conditions of interest occur can be more precisely made, which significantly reduces the effort required when analyzing events which may or may not have caused an unexpected operation to occur.

### BACKGROUND OF THE INVENTION

1. Field of the Invention

The present invention relates to a data processing apparatus. Embodiments of the present invention relate to techniques which assist in debugging the operation of a data processing apparatus.

2. Description of the Prior Art

When developing software code for processing by a data processing apparatus it is desirable to provide techniques which enable the detailed operation of the data processing apparatus when executing that software code to be understood in order that any errors or undesirable or unexpected effects during the execution of the software code can be determined and corrected. These techniques for determining the operation of the software code and for correcting any faults are commonly referred to as debugging.

In order to be able to debug software code, it is often necessary to halt the operation of a data processing apparatus in order that a detailed understanding of the state of that data processing apparatus in response to that software code can be determined. Various techniques for halting or interrupting the operation of a data processing apparatus when processing software code are known.

For example, it is known to insert into the software code to be debugged software instructions, such as a software interrupt instruction, which causes an interrupt to occur during the processing of the software code. When a software interrupt occurs, a number of different operations may be activated. For example, a handler may be activated which then performs a number of further software operations in order to determine whether or not the interrupt which occurred is of interest and, if not, to resume operation of the software code. Alternatively, when a software interrupt occurs, the processor core may enter a debug mode which enables a debug tool residing on a host computer to interact with the data processing apparatus over a dedicated debug interface such as, for example, a JTAG interface, as is known in the art.

Whilst each of these techniques assist in the debugging process, they are generally very time-consuming and it is often the case that it still remains difficult to pinpoint exactly why the data processing apparatus has responded to the software code in that way.

As an alternative to halting the operation of a data processing apparatus, trace techniques are also known when debugging the operation of a data processing apparatus. The trace data generated relates to the operation of the processor core prior to or after a particular event occurring and can be examined in order to understand the operation of the processor core. However, the analysis of trace data can also be very time consuming and complex.

Accordingly, it is desired to provide improved techniques for use when debugging a data processing apparatus.

### SUMMARY OF THE INVENTION

According to a first aspect of the present invention there is provided a data processing apparatus comprising: a processor core operable to process a sequence of instructions; and a watch point unit operable to receive an indication of each of the sequence of instructions being processed by the processor core, the watch point unit being operable to determine whether the indication of each of the sequence of instructions correlates with at least one watch point condition and, if so, the watch point unit being further operable to provide an indication that the at least one watch point condition occurred.

The present invention recognizes that one reason why it is difficult to debug the operation of the data processing apparatus using existing techniques is that it is often very difficult to easily determine when a condition of interest which may cause the inappropriate behavior of the data processing apparatus occurs. For example, known techniques exist which enable watch points to be placed on particular memory addresses or blocks of addresses in memory, and when those addresses are accessed an indication the access has occurred is provided. However, whilst placing watch points based on memory addresses can be useful, such an approach can have limited applicability since other changes in the state of the data processing apparatus other than changes in memory may result in undesirable behavior. For example, changes to data or control registers, changes to units associated with a processor core or changes to other units within data processing apparatus may result in unexpected behavior and these can not necessarily be identified by placing watch points on memory addresses. Also, placing watch points based on memory addresses requires a through knowledge of which memory regions are likely to be associated with any inappropriate operation of the processor in response to particular instructions. In data processing apparatus which use dynamic memory mapping it can be difficult to determine a suitable memory address to be used as a watch point condition since these can vary with time.

Accordingly, a watch point unit is provided which determines from an indication of an instruction being processed by the processor core whether that instruction correlates with a predetermined watch point condition. An indication can then be provided when a watch point condition occurs.

In this way, watch point conditions can be set based on the instructions themselves or features of the instructions rather than being based on a likely effect of that instruction. It will be appreciated this enables a wider range of conditions of interest to be defined which expands the usefulness of debugging. Also, the determination of when the conditions of interest occur can be more precisely made, which significantly reduces the effort required when analyzing events which may or may not have caused an unexpected operation to occur.

In one embodiment, the indication of each of the sequence of instructions comprises a machine code instruction corresponding to that instruction being processed by the processor core.

Accordingly, a machine code instruction representation of the instruction being processed by the processor core may be provided to the watch point unit. It will be appreciated that such a machine code representation will typically be generated by a compiler in response to a mnemonic, the machine code instruction representation encoding the instruction for use by the processor core. The watch point unit may store one or more such machine code instruction representations representing different instructions from the instruction set on which a watch point is to occur.

In one embodiment, each machine code instruction comprises a plurality of fields, each field encoding characteristics of that instruction, the at least one watch point condition comprises a predetermined characteristic of an instruction and the watch point unit is operable to determine whether the indication of each of the sequence of instructions correlates with the at least one watch point condition by determining whether fields of each machine code instruction encode the predetermined characteristic of an instruction.

Hence, the machine code instruction will be provided with a number of fields formatted in accordance with a predetermined encoding arrangement for that instruction. Each field of the instruction will typically represent a characteristic or attribute of that instruction. The watch point unit will determine whether a predetermined characteristic is present in the appropriate fields encoding those characteristics in the machine code instructions. In the event that a match occurs, the watch point unit will provide an indication that the condition has occurred. It will be appreciated that the indication that the condition has occurred can be provided prior to the condition actually occurring because the determination can be made from the machine code instruction which is available prior to any decode or execution of that instruction. This provides for significant benefits since it is then possible to step through the decode or execution of that instruction to determine whether that particular instruction contributed or not to the unexpected behavior of the data processing apparatus.

In known techniques, the only reliable way to track register accesses and/or modifications is to single-step through the software code and then use a debug tool to analyze any changes to the register of interest. It will be appreciated that this approach is extremely time-intensive and requires an extraordinary attention to detail. However, these techniques can not be implemented in with certain types of code, such as OS kernels and other low-level system software.

In one embodiment, the predetermined characteristic of an instruction comprises an indication of a predetermined register accessible by the processor core in response to that instruction and the watch point unit is operable to determine whether the indication of each of the sequence of instructions correlates with the at least one watch point condition by determining whether fields of each machine code instruction encode the indication of the predetermined register.

Accordingly, the characteristic to be determined may include an operation involving a particular register, the watch point unit will determine whether the appropriate field of the machine code instruction for each instruction involves the particular register of interest. In the event that a match occurs then an indication of the match will be provided. Hence, watch points can be set based on access to registers.

It will be appreciated that this provides significant performance improvements over the known approaches which would have required a breakpoint to have been set on every instruction that can possibly have performed the register access. The effort required to identify each of these instructions is extremely high. Also, a large amount of breakpoints would be required or the software code would need to be re-run with a different subset of breakpoints defined each time. However, by having a watch points set by register accesses, the watch point unit is able to determine using a single watch point condition register all accesses to the register of interest, regardless of how many instructions potentially access the register or where those instructions are located in the software code.

In one embodiment, the predetermined characteristic of an instruction comprises an indication of a plurality of predetermined registers and the watch point unit is operable to determine whether the indication of each of the sequence of instructions correlates with the at least one watch point condition by determining whether fields of each machine code instruction encode the indication of the plurality of predetermined registers.

Hence, the condition of interest may relate to the occurrence of an access to more than one register and the watch point unit will determine from the fields associated with each machine code instruction whether that instruction is associated with the registers of interest.

In one embodiment, the predetermined characteristic of an instruction comprises an indication of a predetermined operation and the watch point unit is operable to determine whether the indication of each of the sequence of instructions correlates with the at least one watch point condition by determining whether fields of each machine code instruction encode the indication of the predetermined operation.

Accordingly, even the occurrence of particular operations themselves, rather than accesses to particular registers of other architectural state, can be determined and used to activate a watch point condition.

In one embodiment, the predetermined characteristic of an instruction comprises an indication of a predetermined conditional attribute and the watch point unit is operable to determine whether the indication of each of the sequence of instructions correlates with the at least one watch point condition by determining whether fields of each machine code instruction encode the indication of the predetermined conditional attribute.

In one embodiment, the watch point unit comprises a plurality of watch point condition registers, each watch point condition register being operable to store at least one of the watch point conditions.

Hence, the watch point unit is provided with a number of watch point condition registers. Each of these registers may store one or more watch point conditions.

In one embodiment, each watch point condition register is operable to store a machine code instruction including at least one field encoding the predetermined characteristic of an instruction.

Hence, the watch point condition registers may store machine code representations indicating conditions of interests.

In one embodiment, wherein each watch point condition register comprises a control portion register and a instruction portion register, the instruction portion register being operable to store a machine code instruction, the control portion register being operable to store a mask, and the watch point unit is operable to determine whether the indication of each of the sequence of instructions correlates with the at least one watch point condition by determining whether fields of each machine code instruction masked by the mask match the machine code instruction stored by the instruction portion register masked by the mask.

Hence, by using a mask in combination with the machine code instructions stored in the watch point condition register it is possible to generate any specific watch point conditions which may be of interest. The mask may then be applied to the instruction stored in the instruction portion register and also to any machine code instruction received by the watch point unit in order to determine whether a match occurs. For example, in the event that the register of interest is a control register, the mask may be utilized to enable an indication to be provided only when one bit or series of bits within that register (which may be used to specify particular modes of operation) are accessed. It will be appreciated that this enables switching mode to be reliably tracked which greatly simplifies porting various operating systems to various platforms.

Also, by setting the mask appropriately, different conditions for the same control register may be determined using a single watch point condition register. For example, one watch point condition register may be used to watch for both a memory management unit and a cache being enabled or disabled (assuming these are controlled using the same control register).

In one embodiment, the instruction portion register is further operable to store an memory address, the control portion register is operable to provide an indication that the instruction portion register stores an address and the watch point unit is further operable to determine whether each of the sequence of instructions correlates with at least one watch point condition by determining whether an address associated with each instruction being processed by the processor matches the memory address stored by the instruction portion register.

Accordingly, the instruction portion register may also contain memory addresses and the control portion register can provide an indication that the instruction portion contains an address, thereby reusing the instruction portion register to enable watch points to be performed using both addresses and instructions.

In one embodiment, the watch point unit is further operable to determine whether execution of each of the instructions by the processor core causes a predetermined condition associated with the at least one memory location to occur and, if so, the watch point unit being further operable to provide an indication that the predetermined condition has occurred.

In one embodiment, the indication that the at least one watch point condition occurred comprises a watch point event signal.

It will be appreciated that the watch point event signal can be used for a variety of purposes.

In one embodiment, the processor is operable to perform an interrupt in response to the watch point event signal.

In one embodiment, the processor is operable to activate debug mode in response to the watch point event signal.

In one embodiment, the processor is operable to activate an event handler in response to the watch point event signal.

In one embodiment, the processor is operable to activate a trace unit in response to the watch point event signal.

According to a second aspect of the present invention, there is provided a method of detecting watch point conditions comprising the steps of: receiving an indication of each of a sequence of instructions being processed; determining whether the indication of each of the sequence of instructions correlates with at least one watch point condition and, if so, providing an indication that the at least one watch point condition occurred.

In embodiments, there is provided method steps corresponding to functions performed by features of the first aspect.

According to a third aspect of the present invention there is provided a watch point unit comprising: receiving means for receiving an indication of each of a sequence of instructions being processed by a processor core; determining means for determining whether the indication of each of the sequence of instructions correlates with at least one watch point condition; and indicating means, responsive to the determining means determining that at least one watch point condition occurred, for providing an indication that the at least one watch point condition occurred.

In embodiments, there is provided features corresponding to those of the first aspect.

The above, and other objects, and features and advantages of this invention will be apparent from the following detailed description of illustrative embodiments which is to read in conjunction with the accompanying drawings.

### DESCRIPTION OF THE DRAWINGS

Embodiments of the present invention will now be described with reference to the accompanying drawings in which:

FIG. 1 illustrates an embodiment of a data processing apparatus according to one embodiment of the present invention;

FIG. 2 illustrates example contents of the watch point condition registers illustrated in FIG. 1; and

FIG. 3 is a flow chart illustrating the operation of the data processing apparatus of FIG. 1.

### DESCRIPTION OF THE EMBODIMENTS

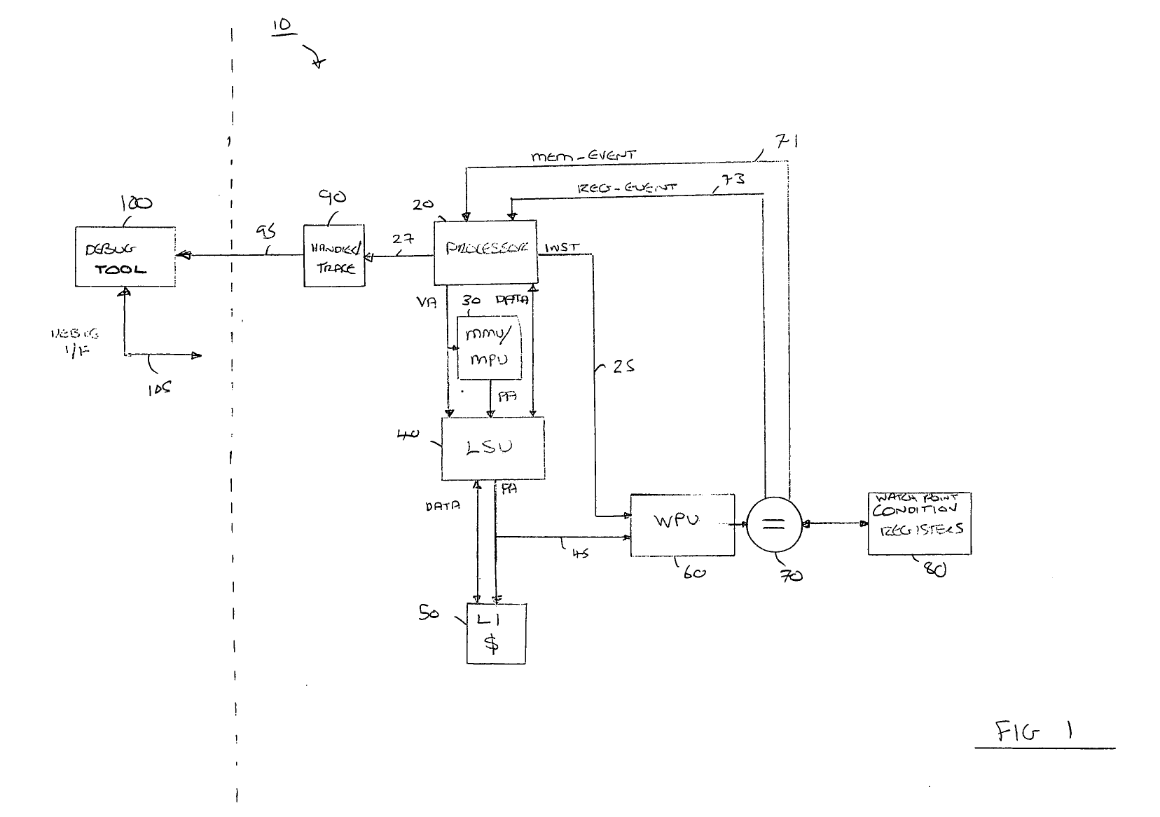

FIG. 1 illustrates an embodiment of a data processing apparatus, generally 10 according to one embodiment. The data processing apparatus 10 comprises a processor core 20 coupled with a memory management unit or memory protection unit 30 which is operable to manage memory accesses. The memory management unit/memory protection unit 30 translates virtual addresses provided by the processor core 20 into physical addresses for use by a load/store unit 40 when accessing memory locations in, for example, a level one cache 50 or other higher level memories (not shown). The load/store unit 40 transfers data between the level one cache 50 and the processor core 20 in response to instructions being processed by the processor core 20.

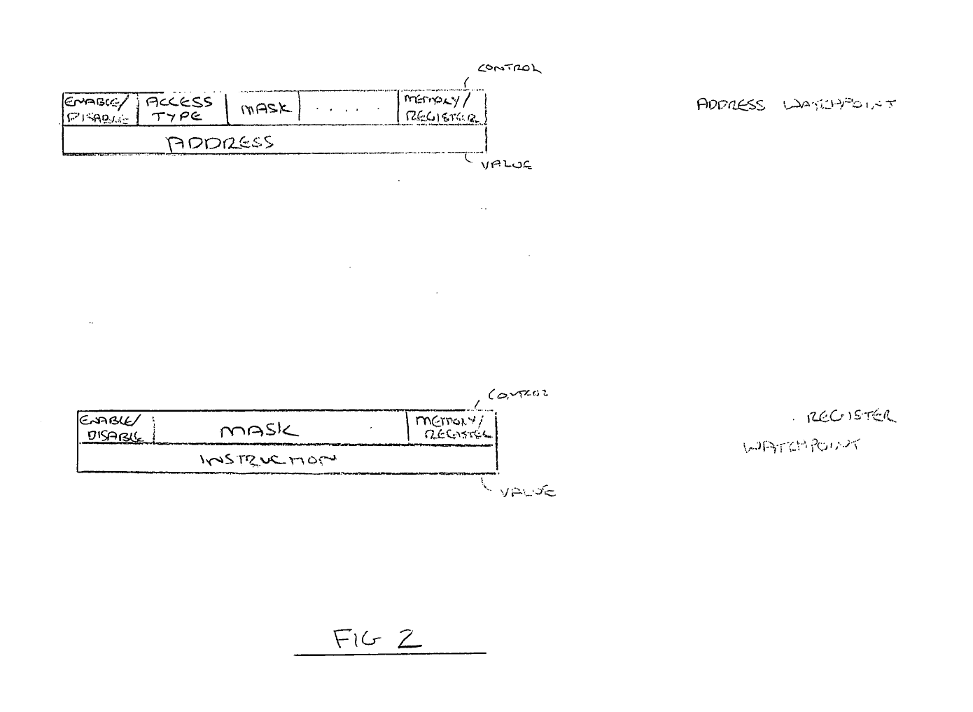

The address provided by the load/store unit 40 is also provided over a path 45 to a watch point unit 60. The watch point unit 60, as will be described in more detail with reference to FIG. 2, compares the address received from the load/store unit 40, using comparison logic 70, with any addresses or address ranges stored in one or more watch point condition registers 80. If the address of an instruction being processed by the processor core 20 matches or falls within a range specified by the watch point condition registers, then a memory event signal is asserted over a memory event path 71 coupling the comparison logic 70 with the processor core 20 and a matched condition register associated with the appropriate one of the watch point condition registers 80 is set to indicate which of the conditions occurred. The processor core 20, in response to the memory event signal being asserted on the path 71, determines an appropriate action to be performed in response to the memory event signal and will, if required, activate a handler/trace unit 90 which, in turn, will activate a debug tool 100, as required. The debug tool 100 will access information relating to the state of the processor core 10 via the debug interface 105, which may be a JTAG interface or the like.

Also, as each instruction is processed by the processor core 20, a machine code representation of that instruction is provided over the path 25 to the watch point unit 60. The comparison logic 70 compares the machine code instruction received by the watch point unit 60 with machine code instructions stored by the watch point condition registers 80. In the event that a match occurs, a register event signal is asserted over a register event path 73 coupling the comparison logic 70 with the processor core 20 and a matched condition register associated with the appropriate one of the watch point condition registers 80 is set to indicate which of the conditions occurred. The processor core 20, in response to the register event signal, determines whether any action needs to be taken. In the event that action does require to be taken then a signal is asserted over the path 27 to activate a handler/trace unit 90. Thereafter, the handler/trace unit 90 will provide a signal at the appropriate time over the path 95 to a debug tool 100. The debug tool 100 will access information relating to the state of the processor core 10 via the debug interface 105.

Accordingly, in this way, as each instruction is processed by the processor core 20, details of addresses being accessed by that instruction, together with details of the instruction itself are provided to the watch point unit 60. Comparison logic 70 compares this information with conditions stored by the watch point condition registers 80. In the event that a match occurs then a signal is provided to the processor core 20. Thereafter, the appropriate action in response to the condition occurring may be taken.

FIG. 2 illustrates in more detail example contents of the watch point condition registers. It will be appreciated that the detailed contents of these registers will vary from application to application, depending on the particular instruction set, formatting of control registers or memory addressing schemes used. Each watch point condition register comprises two portions, a control portion and a value portion. In this example both the control portion and the value portion are 32 bits.

For an address watchpoint, the value portion stores an address value for which read and write accesses are to be monitored. The control portion contains an indication (1 bit) of whether the watchpoint is enabled or disabled, an indication (2 bits) of the access type to be detected (such as read, write or both), a mask (8 bits) to be applied to the memory address in order to detect accesses to addresses within a memory region, an indication (1 bit) of whether the watchpoint relates to an address watchpoint or a register watchpoint, together with other attributes (not shown).

For a register watchpoint, the value portion stores the relevant portions of those instructions on which a watchpoint is to occur (these can be any instruction within the instruction set or sets). In particular, the value portion stores the bit pattern representing the register, operation or condition on which a watchpoint is to occur. The control portion contains an indication (1 bit) of whether the watchpoint is enabled or disabled, an indication (2 bits) of the access type to be detected (such as read, write or both), an indication (1 bit) of whether the watchpoint relates to an address watchpoint or a register watchpoint, together with other attributes (not shown). Also provided within the control portion is a mask to be applied to select or deselect portions of the data stored in the value portion. For example, the mask may be set to determine whether a particular register of interest (such as a control register), has been accessed which causes a particular mode of operation to occur by virtue of a particular bit within the control register being set to a particular value.

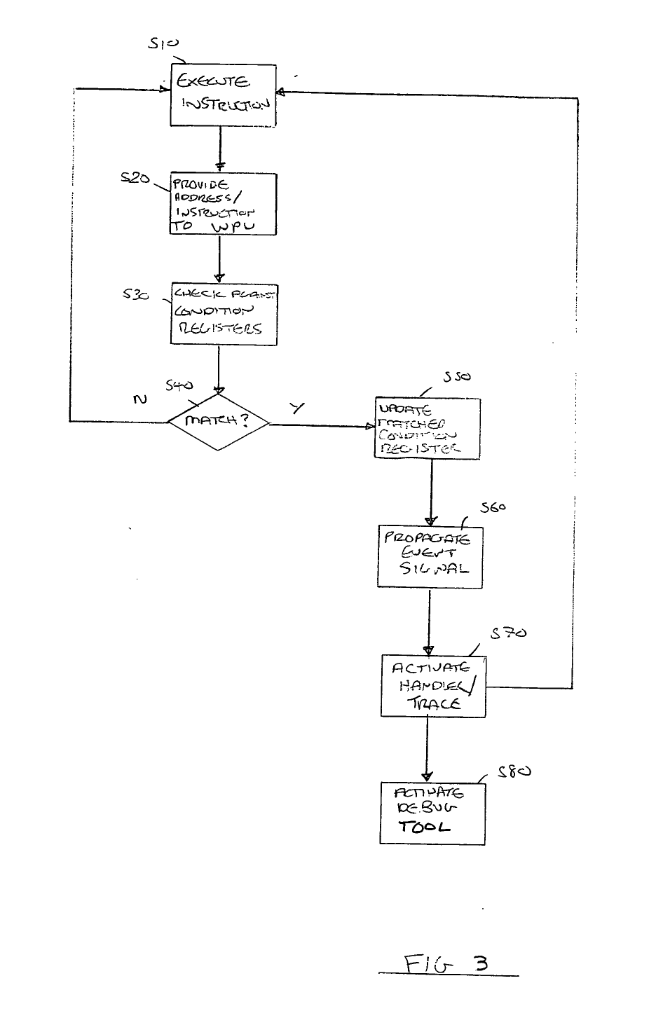

FIG. 3 illustrates in more detail the operation of the data processing apparatus 10 shown in FIG. 1.

At step S10, an instruction is received by the processor core 20 for processing.

At step S20, details of the instruction and the address associated with that instruction are provided to the watch point unit 60.

At step S30, the details provided to the watch point unit 60 are checked against those in the watch point condition registers 80.

At step S40, it is determined whether any of the watch point conditions stored by the watch point condition registers 80 are matched. In the event that no match occurs, processing returns to step S10 whereby the next instruction to be processed is awaited. However, it is determined that a match occurs then the watch point unit 60 then processing proceeds to step S50.

At step S50, a matched condition register associated with the particular watch point condition register which stored the condition which resulted in a match is updated.

At step S60, the relevant event signal is propagated to the processor core 20.

At step S70, the processor core 20 determines what action to take. In the event that no further action is required then processing returns to step S10 where the next instruction to be executed is awaited. However, if it is appropriate to activate the debug tool 100 then, at step S80, the debug tool is activated and processing by the data processing apparatus 10 is halted until further instructions are received from the debug tool 100.

Hence, it can be seen that watch point conditions can be set based on the instructions themselves (which perform normal data processing operations) rather than being based on a likely effect of that instruction. This allows a wider range of conditions of interest to be defined which expands the usefulness of debugging. Also, the determination of when the conditions of interest occur can be more precisely made, which significantly reduces the effort required when analyzing events which may or may not have caused an unexpected operation to occur.

Although illustrative embodiments of the invention have been described in detail herein, with reference to the accompanying drawings, it is understood the invention is not limited to those precise embodiments, and that various changes and modifications can be affected therein by one skilled in the art without departing from the scope and spirit of the invention as defined by the appended claims.

We claim:

1. A data processing apparatus comprising:
a processor core operable to process a sequence of instructions; and
a watch point unit operable to receive an indication of each of said sequence of instructions being processed by said processor core, said watch point unit being operable to determine whether said indication of each of said sequence of instructions correlates with at least one watch point condition and, if so, said watch point unit being further operable to provide an indication that said at least one watch point condition occurred.

2. The data processing apparatus of claim 1, wherein said indication of each of said sequence of instructions comprises a machine code instruction corresponding to that instruction being processed by said processor core.

3. The data processing apparatus of claim 2, wherein each machine code instruction comprises a plurality of fields, each field encoding characteristics of that instruction, said at least one watch point condition comprises a predetermined characteristic of an instruction and said watch point unit is operable to determine whether said indication of each of said sequence of instructions correlates with said at least one watch point condition by determining whether fields of each machine code instruction encode said predetermined characteristic of an instruction.

4. The data processing apparatus of claim 3, wherein said predetermined characteristic of an instruction comprises an indication of a predetermined register accessible by said processor core in response to that instruction and said watch point unit is operable to determine whether said indication of each of said sequence of instructions correlates with said at least one watch point condition by determining whether fields of each machine code instruction encode said indication of said predetermined register.

5. The data processing apparatus of claim 3, wherein said predetermined characteristic of an instruction comprises an indication of a plurality of predetermined registers and said watch point unit is operable to determine whether said indication of each of said sequence of instructions correlates with said at least one watch point condition by determining whether fields of each machine code instruction encode said indication of said plurality of predetermined registers.

6. The data processing apparatus of claim 3, wherein said predetermined characteristic of an instruction comprises an indication of a predetermined operation and said watch point unit is operable to determine whether said indication of each of said sequence of instructions correlates with said at least one watch point condition by determining whether fields of each machine code instruction encode said indication of said predetermined operation.

7. The data processing apparatus of claim 3, wherein said predetermined characteristic of an instruction comprises an indication of a predetermined conditional attribute and said watch point unit is operable to determine whether said indication of each of said sequence of instructions correlates with said at least one watch point condition by determining whether fields of each machine code instruction encode said indication of said predetermined conditional attribute.

8. The data processing apparatus of claim 1, wherein said watch point unit comprises a plurality of watch point condition registers, each watch point condition register being operable to store at least one of said watch point conditions.

9. The data processing apparatus of claim 8, wherein each watch point condition register is operable to store a machine code instruction including at least one field encoding said predetermined characteristic of an instruction.

10. The data processing apparatus of claim 8, wherein each watch point condition register comprises a control portion register and a instruction portion register, said instruction portion register being operable to store a machine code instruction, said control portion register being operable to store a mask, and said watch point unit is operable to determine whether said indication of each of said sequence of instructions correlates with said at least one watch point condition by determining whether fields of each machine code instruction masked by said mask match said machine code instruction stored by said instruction portion register masked by said mask.

11. The data processing apparatus of claim 10, wherein said instruction portion register is further operable to store an memory address, said control portion register is operable to provide an indication that said instruction portion register stores an address and said watch point unit is further operable to determine whether each of said sequence of instructions correlates with at least one watch point condition by determining whether an address associated with each instruction being processed by said processor matches said memory address stored by said instruction portion register.

12. The data processing apparatus of claim 1, wherein said watch point unit is further operable to determine whether execution of each of said instructions by said processor core causes a predetermined condition associated with said at least one memory location to occur and, if so, said watch point unit being further operable to provide an indication that said predetermined condition has occurred.

13. The data processing apparatus of claim 1, wherein said indication that said at least one watch point condition occurred comprises a watch point event signal.

14. The data processing apparatus of claim 13, wherein said processor is operable to perform an interrupt in response to said watch point event signal.

15. The data processing apparatus of claim 13, wherein said processor is operable to activate debug mode in response to said watch point event signal.

16. The data processing apparatus of claim 13, wherein said processor is operable to activate an event handler in response to said watch point event signal.

17. The data processing apparatus of claim 13, wherein said processor is operable to activate a trace unit in response to said watch point event signal.

18. A method of detecting watch point conditions comprising the steps of:
receiving an indication of each of a sequence of instructions being processed;
determining whether said indication of each of said sequence of instructions correlates with at least one watch point condition and, if so, providing an indication that said at least one watch point condition occurred.

19. A watch point unit comprising:
receiving means for receiving an indication of each of a sequence of instructions being processed by a processor core;
determining means for determining whether said indication of each of said sequence of instructions correlates with at least one watch point condition; and
indicating means, responsive to said determining means determining that at least one watch point condition occurred, for providing an indication that said at least one watch point condition occurred.
